(19) United States
(12) Patent Application Publication
(10) Pub. No.: US 2005/0157511 A1
(43) Pub. Date: Jul. 21, 2005

(54) Safety lighting for vehicle outside mirrors

(76) Inventor: John Nixon, Brighton, MI (US)

Correspondence Address: John Nixon, 11795 E. Grand River, Brighton, MI, 48116-8534, US

(21) Appl. No.: 10/760,157

(22) Filed: Jan. 20, 2004

(51) Int. Cl. B60Q 1/00

(52) U.S. Cl. 362/487

(57) ABSTRACT

A method of signaling vehicle operation by using lamp assemblies on the left and right outside rear view mirror housings, to show Running, Clearance , Braking and Hazard conditions and change of steering direction. The lamp assemblies are mounted on a molded neoprene base which is also formed to provide a tubular bumper for physical protection of the lenses and to give an alarm signal. The lamps , each consist of four light emitting diodes (L.E.D.'s) in keyed plug in assemblies, are located on the rear and on the underside rearwards of the mirror housings. In the preferred form of the invention, the change in steering direction is indicated by switches mounted on the steering column and actuated by on operator on the steering wheel. The control of the indicating lamps is by solid state integrated circuitry located in a central box. The running-clearance lamp is located at the rear of each housing and lit when the vehicle ignition is on. Four directional lamps, located on the underside of each housing are controlled by the steering direction switch, the near lamp lights as the steering wheel is turned a few degrees from the straight ahead position and remains on until returned, indicating a possible lane change. Further turning lights the second followed by the third and the fourth in a timed sequence, then switches off. This repeats until reset by a vehicle turn signal in the opposite direction or over-ridden by a braking or a hazard condition or return to the straight ahead position. A braking signal will cause the lights on each mirror housing to stay on steady and a hazard condition will cause all lights to flash.

### BACKGROUND OF THE INVENTION

1. Field of the Invention

The present invention relates to light emitting diode (L.E.D.) lamp assemblies mounted as a unit on the vehicle outside mirror housings to provide safety indication of vehicle operation.

11. Description of the Prior Art

Large trucks have for years been fitted by their owner operators with strip lighting for running lights and with small lights on the rear of their driving mirrors for braking and directional signals. Lights have been fitted recently on the mirrors of some pick-ups and S.U.V.'s such as G.M.C. 2002 Envoy and on the Ford Windstar minivan and on autos such as the Mercedes Benz C class. Some supplied on mirrors made by Donnelly Corp. of Holland, Mich. and Ichikob Manufacturing Inc., of Novi, Mich.

### SUMMARY OF THE PRESENT INVENTION

The present invention provides a unique means for enhancing the safety of vehicle operation using lamp assemblies located on the underside rearwards and on the rear of the mirror housings and out of the line of vision of the vehicle operator. Both lights visible to approaching vehicles and the underside lights visible to following vehicles.

The lamp assemblies consist of light emitting diodes (L.E.D.s) units of four mounted on a single unit neoprene base. The L.E.D.s use tiny amounts of energy and operate for days with the vehicle stopped and the hazard lamps flashing, without discharging the battery.

### BRIEF DESCRIPTION OF THE DRAWINGS

A better understanding of the present invention will be had upon reference to the following detailed description when read in conjunction with the accompanying drawings, where like reference characters refer to like parts through several views , and in which:

FIG. 1. Is a front view of the embodiment. Partly in section.

FIG. 2. Is a sectional view of this embodiment, of the line 11

FIG. 3. Is a view of a L.E.D. lamp assembly, Detail 3, full size.

FIG. 4. Is a front view of the switch assembly.

FIG. 5. Is a top view of the switch assembly, full size, line V.

FIG. 6. Is a sectional view of the switch assembly, full size, line V1

FIG. 7. Is a view of the switch mounting angles

FIG. 8. Is a solid state schematic diagram of this embodiment.

### DETAILED DESCRIPTION OF THE PRESENT INVENTION

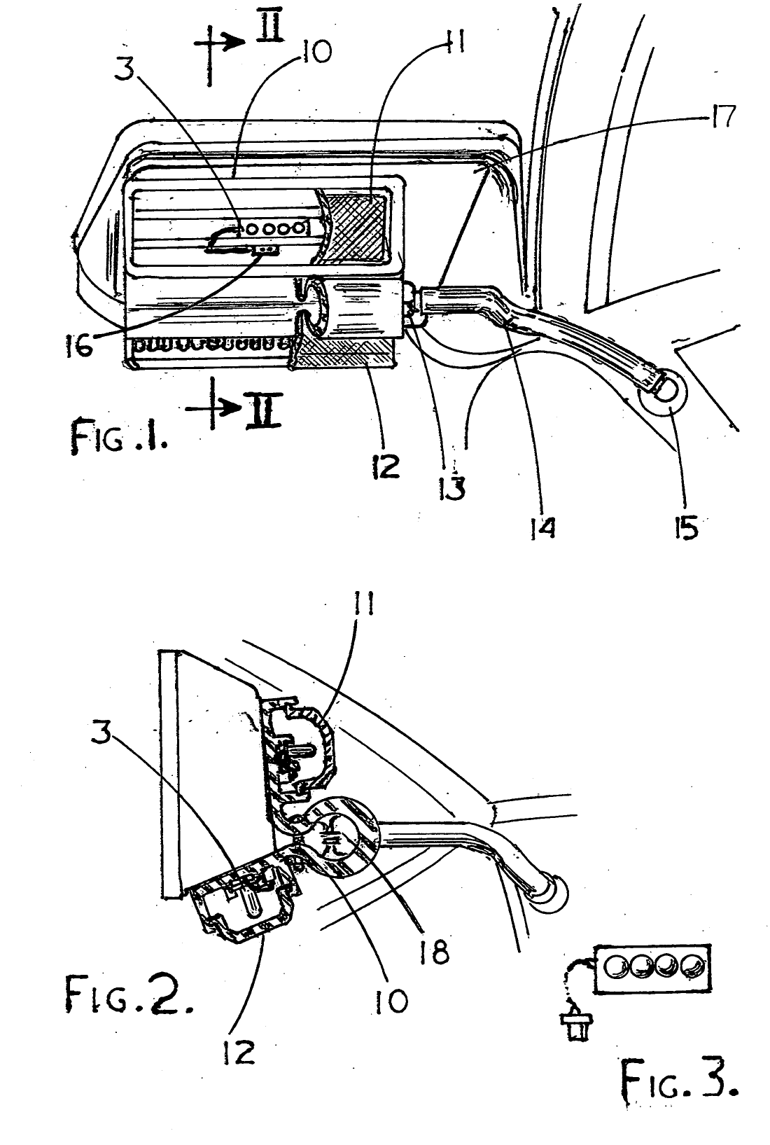

As best shown in FIGS. 1, 2 and 3, the lamp assembly is formed in a single base 10 of 6o-70 durometer neoprene that can be applied to fit various shaped housings. Also molded as part of the base is a tubular bumper to offer protection to the lenses 11 and 12 and to carry alarm switch 18 and the wiring for the lamps 3. The lamps press into formed holders and connect to sockets 16, and the lenses, white 11 and amber 12 press into the formed base. A single lamp fits under the white lens and four lamps fit under the amber. A flexible hose 14 carries the wiring and through connector 13 joins the safety bumper to the vehicle fender through connector 15. The wiring may also be made internally through the passenger door. An adhesive backed metallic silvered tape 17 attaches to the underside of the mirror housing and forms snugly around the rear to reflect the light. The base 10 fits over the tape and mounts by adhesive and screws to the mirror housing. Switch 18 is operated if the bumper is depressed and switches on the hazard condition.

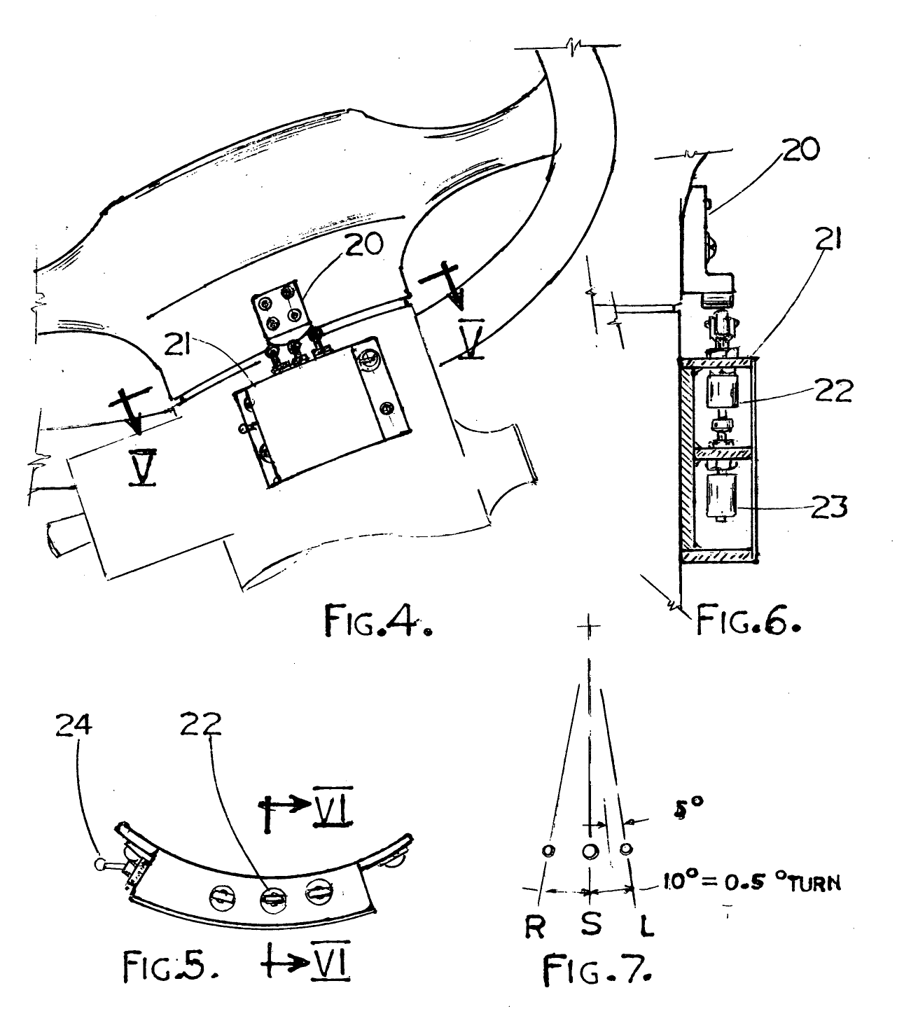

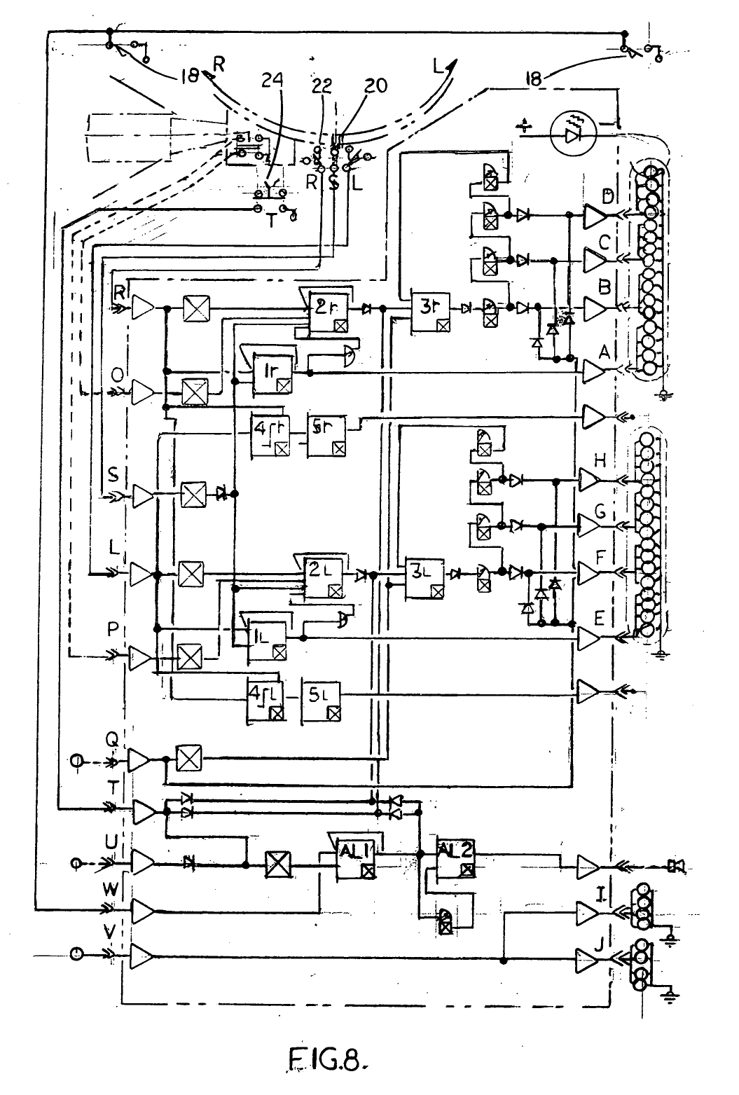

As best shown in FIGS. 4, 5, and 6, the switch housing 21 mounts on the steering wheel column adjacent to the directional lever, the switch operator 20 mounts on the steering wheel casting, the switch operator and the switch housing are positioned so that operator 20 trips central switch 23 when the steering wheel is in the straight ahead position. As best shown in FIG. 7 the straight ahead position switch is at S and a 5 degree steering wheel turn right will trip switch R and a 5 degree steering wheel turn left will trip switch L, the operater 20 being 10 degrees wide will trip either switch L or switch R before releasing switch S. A lamp lights either right or left on the near underside of the lamp assembly indicating a possible lane change. Returning to the straight ahead position switches off the lights. Further turning of the steering wheel in either direction will signal a moving change and the second , the third and the fourth lamps light and turn off in timed sequence to indicate turning direction. The lights will reset by returning to the straight ahead position. Switch intermediates 22 change a cam motion into a down thrust. Toggle switch 24 provides the hazard signal and also resets the bumper alarm.

### Detailed Description of A Preferred Embodiment of The Invention, The Logic Control Schematic Diagram

As best shown in FIG. 8:

Vehicle inputs (I/P's) connected to the logic circuit:
P. Connected to the ‘right turn’ wiring.
O. Connected to the ‘left turn’ wiring.
Q. Connected to the ‘brake on’ wiring.
U. Connected to the ‘in reverse’ wiring.
V. Connected to the ‘Ignition on’ wiring
W. Connected to the ‘Hot all time’ through alarm switch.

Switch assembly inputs (I/P's) connected to the logic circuit:
S. Steering wheel in ‘straight ahead’ position
R. Steering wheel in ‘turning Right’ position
L. Steering wheel in ‘turning Left’ position
T. Hazard switch “on’ and alarm cancel ‘on-off’.

Vehicle outputs (O/P's) connected to the logic circuit shown:

For the right hand rear view mirror housing
A. Switch on the lamp nearest R.H. door, vehicle moving right
B. Switch on next lamp, vehicle turning right and after delay
C. Switch on next lamp, and after delay
D. Switch on next lamp, and after delay, switch off ‘B’ and reset After delay, repeat ‘B’, ‘C’, ‘D’, sequence.
I. Switch on lamp, running light.

For the left hand rear view mirror housing
E. Switch on the lamp, nearest L.H. door, vehicle moving left
F. Switch on next lamp, vehicle turning left and after delay
G. Switch on next lamp, and after delay
H. Switch on next lamp, and after delay, switch off ‘F’ and reset After delay, repeat ‘F’, ‘G’, ‘H’, sequence
J. Switch on lamps, running and clearance lamps.

### Steering Directional Signaling, Logic Circuit Operation

Right hand assembly—left hand similar.

Turning right a few degrees releases switch S and removes I/P from the ‘not’ unit and gives the I/P to the ‘sealed and’ unit 1r, further turning trips switch R and gives input to seal in 1r, O/P from unit 1r gives I/P to modifier A and the ‘moving right’ lamp lights. Returning to the ‘straight ahead’ position trips switch S and removes I/P to reset unit 1r. Further turning from the ‘moving right’ condition releases switch R and gives input to unit 2r, with ‘not’ I/P's O and S and timed I/P from unit 1r, unit 2r seals in and provides I/P to unit 3r. Unit 3r gives I/P to dwell timer and I/P to modifier B and the first of the ‘turning right’ lamps light. After a short dwell, timer gives I/P to modifier C and the second of the ‘turning right’ lamps light, after a short dwell a timer gives an I/P to modifier D and the third of the ‘turning right’ lamps light. Another short dwell timer will turn off unit 3r to reset all timers to repeat the B, C, and D cycle to provide a flashing ‘turning right’ indication.

Operation of the left hand vehicle turn signal removes output at O to reset unit 2r and reset unit 3r and B, C, and D, and turn off the ‘turning right’ signaling. Returning to the ‘straight ahead’ position trips switch S and resets all units.

Units 4r and 5r give a 360 degree turn right signal for indication only.

Further logic circuit operations:

A ‘brake on’ I/P signal at Q removes I/P's to units 3r and 3l and gives inputs to modifiers B,C,D and F,G,H, to light their respective lamps, A ‘vehicle in reverse’ I/P at U, a ‘hazard’ I/P at U, an ‘alarm’ I/P at W gives I/P's to units 3r and 3l and then through their respective timers to modifiers B,C,D, and F,G,H, to sequence and light the left and right hand lamps.

A ‘ignition on’ signal at V gives I/P's at modifiers I and J to light the left and right hand running and clearance lamps.

1. For use in conjunction with a vehicle having outside rear viewing mirrors mounted on the right and left hand sides, a device for signaling the operation of said vehicle by applying electrical lighting as a an addition to and as an integral part of the outside rear view mirror housing, comprising: means of attaching said signaling device, forming to said mirror housing, and indicating vehicle running, clearance, braking, hazard, and directional turning and lane changing signals, from electrical signals generated from a device on the steering mechanism of said vehicle and from the said vehicles electrical signals, and means to control functions of said signaling device.

2. The invention as defined in claim 1 wherein the attachment means comprises a formed base of flexible material characterized by neoprene or rubber or plastics and molded to hold electrical light emitting assemblies, connecting sockets, plastic lenses, ducting for electrical wiring.

3. The invention as defined in claim 2, wherein light emitting assemblies characterized by light emitting diodes (L.E.D's), krypton, xenon, halogen or incandescent bulbs, one or more close mounted in line on a printed circuit board with connections to a small plug.

4. The invention as defined in claim 2, wherein the attachment means is mounted to the said mirror housing providing one light emitting assembly at the rear of the housing, indicating vehicle running and clearance and covered by a lens, four light emitting assemblies , on the underside of the housing indicating, vehicle braking, hazard and directional change and covered by a lens.

5. The invention as defined in claim 1 wherein the vehicle steering mechanism directional signaling device, consisting of an operator attached to the steering mechanism giving an electrical output when in the straight ahead position, when moved a few degrees to the right or left the output changes, further movement giving an output either right or left and the two conditions combining to signal a changing of direction, a possible lane change by energizing the first of the four directional light emitting assemblies nearest the vehicle side, further movement of the steering mechanism either right or left changing the output and causing the second, third and forth light emitting assemblies to flash in sequence and repeat until the steering mechanism returns to the straight ahead position; the three directional sequencing light emitting assemblies interlock with a vehicle operator turning signal, switching off with an opposite over-riding turning signal.

6. The invention as defined in claim 2, wherein the said attachment means contains a safety bumper positioned between the two light emitting assemblies at the rear and the underside of the housings, the tubular bumper, formed from the base flexible material and sized to protect the light assemblies and containing electrical contact strips to close on impact and giving an electrical output.

7. The invention as defined in claim 1, wherein a braking signal connects the vehicle “brake on” wire, as the vehicle brake is applied, energizing the second, third and fourth light emitting assemblies on both sides of the vehicle.

8. The invention as defined in claim 1, wherein a hazard signal is given when reversing the vehicle energizing the “in reverse” vehicle connection, sequencing the second, third and fourth light emitting assemblies on both sides of the vehicle, the signal is also controlled by an on-off switch and by alarm switches on the safety bumpers both connected to the “hot at all times” wire.

9. The invention as defined in claim I, wherein the running and clearance light emitting assembly is energized by the vehicle “ignition on” signal.

10. The invention as defined in claim 1, wherein the logic circuitry is of solid state integrated construction.
